(19) United States
(12) Patent Application Publication
(10) Pub. No.: US 2006/0047709 A1
(43) Pub. Date: Mar. 2, 2006

(54) Technology independent information management

(76) Inventors: Sven Johan Belin, Stockholm (SE); Mats Goran Blomberg, Saltsjobaden (SE); Permilla Rut Charlotte Flyg, Nacka (SE); Nils Martin Agren, Hasselby (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/525,769

(22) PCT Filed: Sep. 5, 2002
(86) PCT No.: PCT/SE02/01594

§ 371 Date: Feb. 28, 2005

(30) Foreign Application Priority Data
Sep. 5, 2001 (US) 60317296

(51) Int. Cl. G06F 17/30

(52) U.S. Cl. 707/201

(57) ABSTRACT

A method, system and computer program for processing data objects in a distributed data processing system, said distributed data processing system having a plurality of software and/or hardware nodes being communicatively connectable. The method comprises the steps of defining first and second environments for processing objects at differ levels of abstraction, namely a first platform independen level and a second platform dependent level operating with different categories of object aspects. Each object is defined according to two object models, one for the platform independent environment and one for the platform dependent environment. The two object models are syncronized and object instances generated on the basis of said models are processed in the respective environments dependent on the aspects of the current object instance.

### TECHNICAL FIELD

The present invention relates generally to management and access of information. More specifically, the present invention relates to technology or platform independent management and access of information, computer implemented services and computerized functionality.

### BACKGROUND

As a consequence of the continuous development of computers and the increasing use of computers in a wide variety of applications, different branches of human activities such as telecommunications, business or work related tasks and entertainment are merging into a common mainstream of information technology. Whereas the concepts for the handling of information, services and computerized tools has come far ahead, the practical use of information technology is often hampered by the wide variety of different technical solutions and platforms for storing, displaying, executing and transferring information or data. There is thus a need for simpler access and handling of the different kinds and realizations of information technology.

### PRIOR ART

There is prior art addressing the mentioned need. In for example the technical report Current Technologies for Device Independence, Mark H. Butler, Publishing Systems and Solutions Laboratory, HP Laboratories Bristol, HPL-2001-83, Apr. 4, 2001 there is a survey of current technologies related to the creation of device independent web content and web applications. This piece of prior art is mainly concerned with the access to internet web sites by means of different kinds of devises.

The patent documents EP1126681 and EP1130510 show different aspects of prior art object oriented technology.

### OBJECT OF THE INVENTION

The overall object of the present invention is to solve the problem of achieving a technological platform where objects for example in the shape of information, executable software code or apparatuses with possibly heterogeneous properties can interact and collaborate in manner that is perceived to be homogeneous.

Different aspects of the problem are:
To enable availability and accessability of information as well as logic in the form of processing rules or executable program code for different types of processing and interfacing software or hardware devices independent of their basic technology or platform.
To enable collaboration between different logic components, i.e. pieces of executable software code, independent of hardware configuration, network topology, program language semantics, transaction protocols, logic implementation language, physical differentiation and the like.
To enable a more economic software development in terms of possibility to optimize the size of software modules.
To provide a seamless transition between software objects and software components.
To provide homogenous access to external resources, such as data sources, executable software code or hardware devices.
To provide an environment for rapidly creating powerful, truly distributed systems in a manner that is simple and time efficient as well as production cost efficient.
To enable implementation of objects, in the sense of object oriented programming technology, in one or more programming languages in order to allow for selectability of language dependent on the current purpose or task.

### SUMMARY OF THE INVENTION

The above mentioned object and the different problem aspects are in accordance with the invention addressed by means of an improved object oriented concept thinking realized in a distributed object oriented architecture (in short herein also called object architecture). The inventive distributed object oriented architecture comprises an object definition language, which is a subset of the eXtensible Markcup Language. The Object Definition Language enables object developers to define objects, independent of hardware-technology, -configuration, network-topology, -semantics, -protocols, logic implementation language and physical differentiation. It provides the developer with an abstraction, enabling the developer to focus on the object's interface and functionality. This enables the developer to isolate the native/technology-dependent aspects of the object.

More generally, the objects of the invention is achieved by means of the below method for processing data objects in a distributed data processing system, and realizations in the form of a system or a computer program product. The distributed data processing system has a plurality of software and/or hardware nodes that are mutually communicatively connectable or couplable.

An embodiments of the method comprises the steps of:
defining a first environment, called object runtime environment, for processing objects at a first level of abstraction that is independent of the software/hardware platform of said nodes;
defining a second environment, called native environment, for processing objects at a second level of abstraction that is dependent on the software/hardware platform of said nodes;
defining in said first environment a first object model with a first category of object aspects, i.e. generic or platform independent aspects;
defining in said second environment a second object model with a second category of object aspects, i.e. native or platform dependent aspects; synchronizing said first object model of said first environment with said second object model of said second environment;
defining an object in accordance with said first and second models associating a selectable set of object aspects from said first and second object aspect categories;
generating an instance of said object;
processing said object instance in said first and second environments dependent on said associated set of object aspects.

In a data processing system comprising hardware and software nodes in which the inventive environments are established objects are thus managed and processed in a manner that fulfills the objects of the present invention.

In a further development of the invention, predefined object connectivity means, in the shape of software code portions and protocols communicatively coupled to said first, platform independent environment, are devised to interface with and execute data communications between an internal entity situated within and an external entity situated without said defined first and second environments.

In one embodiment, an instance of said first, platform independent environment is configured together with an instance of said second, platform dependent environment and object connectivity means to constitute a service provider functionality. Preferably also an instance of said first, platform independent environment is configured together with an instance of said second, platform dependent environment to constitute an object consumer functionality.

Further, a object provider functionality is preferably configured together with and a service consumer functionality constituting a consumer/provider subset of the distributed system, also called a federation (explained below) within which the processing of objects or object instances is performed.

Seamless transition between software objects and software components is achieved by providing a common development model for objects and for software components.

According to the invention information is preferably stored in a common format, heresometimes called the eXtensible Document Format (below also referred to as XDF format) which is the single document format of the system. The XDF format is used to describe any type of functionality or content. There is no type attribute connected to an XDF document, and therefore there is no difference between a data file, such as a document or an image, and an application of executable program code, in the way the information is structured and stored. From the user's point of view, there is no difference between for example a document and a data communications service.

A result and an important feature of the present invention is that a user that operates and interfaces with a data processing system or a data base designed in accordance with the inventive concept may conveniently gain access to the same information with any connectable data communication device independent of its technical platform. That is, the information is accessible whether the user operates from for example a conventional computer, a WAP device, a mobile phone or any other communication device that is connectable to the system via the for example the Internet without the need for any cumbersome conversion or synchronization routines.

The system in accordance with the invention automatically performs any required adaptation or profiling of the format of data for the user to gain access to an object e.g. in the shape of information or a service, such as the processing of data in a user-centric service. Thereby objects according to the invention are made platform independent. A user may thus start working with an object such as a document by means of a service, such as a word processor, by using one type of communication device or processing device, e.g. a desktop computer. Then the user can continue working with the same document using a different type of communication or processing device such as a PDA or WAP phone.

The invention makes it possible to make available upon request different services, for example a word processing service provided at remote site or apparatus, e.g. a central site or another node in a distributed system. A user may thus gain access to the requested word processing service without having a word processing program installed on the communication device that is used by the user to communicate with the system. More generally, a user may gain access to very powerful services, functionalities and resources provided at a remote site or apparatus, e.g. a central site or another node in a distributed system, although the communication device itself is relatively primitive because it is not necessary for the communication device to have any powerful programs installed.

In order to enable a more economic software development in terms of possibility to optimize the size of software modules, the inventive concept comprises functionality to treat objects and components alike. That is, the inventive object architecture does not make any semantic or programmatic difference between an object and a component. When an object becomes more complex, the complexity is delegated for example by means of compositions or aggregations. Objects that delegate functionality then seamlessly transfer to behave like or perhaps even be an entity that in prior art often is referred to as a component. In the invention an object can therefore be developed and treated either as a software component or an object, but the inventive object architecture makes no difference between the two and therefore a program developer is freed to develop a program solution that is neither larger nor smaller than necessary.

Definitions

In this section terms used in the description text are defined and explained. Some terms are also defined and explained in description text itself.

Object

An entity that encapsulates information, processes and behaviors as specified by the accepted principles of Object Orientation. The word is in this text used to define an object built and based on the technology according to the invention, which in some respects differs from prior art definitions. Also the word object is used to identify a non-instantiated object.

Instance or Object Instance

An instantiated object.

External Actor

From the point of view of a current first object, a second object interacting with the first object is an external actor.

ODL

Abbreviation of Object Definition Language.

The Object Definition Language is used within the technology according to the present invention to define objects and in this text refers to a specifically developed language.

Federation

A system according to the invention in which a Provider functionality and a Consumer functionality (explained below) are available.

Deployed Object

When an object is instantiated within an Object

Runtime Environment (explained below) for the first time, some additional steps are required; decoding object definition, merging object definitions, decoding runtime descriptor, cache object definition etc. These additional steps are referred to as deploying an object, object deployment or a deployed object throughout this description. In contrast with prior definition of deployment, here deployment refers to a process that is performed autonomously and not by a system administrator or a developer.

### BRIEF DESCRIPTION OF THE DRAWINGS

FIG. 1 is a schematic collaboration diagram of the operating system of the present invention;

FIG. 2 is a schematic block diagram of illustrating components in embodiments of the invention; and

FIG. 3-5 show exemplifying scenarios of signal communication between different components in embodiments of the invention.

### DETAILED DESCRIPTION OF EMBODIMENTS OF THE INVENTION

The invention is dependent on the application realized as a method, an apparatus or system, or as a computer program product. An apparatus or system would typically comprise data processing means having a central processing unit (CPU), data storage means, an input/output interface and data communication means. The apparatus or system would then be set up to execute steps of the inventive method by means of specifically designed computer program code. The invention, when realized as a computer program product, would typically comprise computer program code portions that are devised to direct a data processing system to perform steps and functionality of the inventive method or apparatus. The invention is explained with reference to schematic drawings that depict functional units that in different embodiments may be realized as method steps, hardware units or computer program code portions. For the sake of simplicity the distinction between different realizations is not always mentioned in the below description of embodiments.

The invention is preferably implemented in terms of an object oriented concept. Objects are created, that is defined and established, exist and operate in an object runtime environment constituted by a possibly distributed system of data processing devices provided with software for realizing a platform independent data processing method in accordance with the invention. Possibly, a plurality of different object runtime environments exists side by side, and may also communicate. There is also a platform dependent layer or environment called native environment in each of the devises in the system. Objects can also exist in the native environment and it is proper to define different aspects of an object, namely the generic, platform independent aspect and the native, platform dependent aspect.

If an object contains one or more native aspects, the object is also defined native as such. Objects that are defined native have two object models, namely one in the Object Runtime Environment and one in the Native Environment. The model existing in the Native Environment is populated with all native aspects of the object. Both object models can interact with each other. For example, native methods can invoke non-native methods within the same object and vice versa (with the extension that objects can invoke native methods in other objects also). Also, any attributes defined native are always kept coherent in the two object models. For example, if the attribute value is changed in one object model, the change is propagated to the other object model.

Preferably, the majority of all objects that are created should be totally platform independent. Only a small number of objects will contain any native representations. Such objects (e.g. Image object, Text object, AudioPlayback object etc.) implement functionality that is futile to support as platform independent, without a devastating amount of development and administrative implementation work. Instead these native objects, i.e. objects containing native aspects, will be the most atomic building blocks for other objects to use.

An effect of the platform independent generic aspect of objects in accordance with the invention is that each object only has to be defined once, and can thereafter be delivered to all different types of devices for which there an object consumer runtime environment (further explained below).

Defining Objects

This section describes preferred embodiments of the object structure of the invention.

Uniqueness:

In operation a number of objects are defined and established as object instances. All object instances are globally unique within the distributed system of nodes and devises that are involved in an implementation of the invention. When an object is instantiated, it is given a globally unique identification number (GUID/UUID). In accordance with the invention a globally unique identification number GUID must be guaranteed uniqueness on all involved software devices within the implementation. The effect of this is that the objects of the invention are or can be truly and entirely distributed in the sense that they can exist on an arbitrary number of clients and communicate with an arbitrary number of servers.

Attributes:

Information (data) is encapsulated in an object by means of attributes associated with the object. An attribute can hold or store basic entities called primitives, more specifically a primitive, a runtime primitive, a custom primitive, or it can hold a reference to another object. An attribute can be declared native, which means that it operates in an environment, called native environment, that is dependent on a specific technical platform at a level below the platform independent level. This is further explained below. In one embodiment of the invention, an attribute is unable to be exposed directly to other objects, instead attributes must be accessed through accessor and mutator methods defined in the invention.

Primitives:

Data of different kinds is accessed or stored through a set of primitives that is used to contain data. Data can also be stored in other objects or object instances that a first object has a reference to, in which case the reference is stored as an attribute. For example, a mail object can have a reference to a recipient object. The storage of more complex data can be realized as a mixture of primitives and objects, and example a mail object can have a collection of attachment objects.

Different embodiments comprise one or more among the following primitives. It is also possible to define other primitives within the inventive concept.

Number

A primitive that can contain any type of numerical value, for example integer, decimal (floating point) or big decimal. The type is determined by the value inputted by the developer of the implementation.

String

A string primitive contains a universal character set transformation format UTF. There are for example an UTF-8 or an UTF-16 string value.

Boolean

A boolean primitive contains a boolean value, for example expressed as a single bit dependent on the implementation.

Collection

A collection primitive is able to contain primitives (including collection primitives), runtime primitives, custom primitives and object references. In a preferred embodiment of the invention the data contained in the collection primitive should be contained in a structure independent way. The collection can then be treated as any type of collection, such as map, vector, array, list, linked list or the like.

Transaction

A transaction resource contains a reference to a globally unique transaction that has been performed or executed.

Runtime Primitives:

Runtime primitives are primitives that are local for the Object Runtime Environment in which they were created and populated. Runtime primitives are transient by nature, and they are not allowed to be serialized and/or distributed to another Object Runtime Environment. When an object is serialized it is stored in a format that can be transmitted over a network or it is stored on a persistent medium, such as a hard disk. In an alternative wording the complex format of an object is stored for example as a binary stream or as an XML-document. In contrast to serialization, when an object is transferred as binary data, an object is distributed by sending an object reference to certain recipients.

Embodiments of the Invention Comprises:

Container

A native container is a runtime primitive that represents a graphical user interface container (e.g. a window) that is used to project presentation objects.

Custom Primitives:

Custom primitives are custom defined primitives, defined by an object vendor or an object developer. An example usage of custom primitives is a primitive pertaining to a Java Technology Object. A custom primitive is by default not transient, but may be declared transient by the object vendor.

Object References:

An attribute can contain a reference to an instance of another object. Such a reference is used to invoke methods that operate on the current object instance.

Object Operation Methods

An object is accessed or activated by means of an object operation method, which is a portion of executable software code designed to perform a specific task of the object. In a preferred embodiment of the invention, the object operation methods is the only part of the object that is directly exposed to other objects and is available in order on one hand to execute functionality or operations and on the other hand to access or manipulate data that is encapsulated in the object. Each object operation method has a definition that defines its name and its return value. For each object operation method an unlimited number of unique method implementations can be declared. The uniqueness of an object operation method implementation, or an object operation method signature, is based on the number of arguments, argument names, and argument types it requires. In one embodiment, in the case that two implementations have the same number of arguments, they are differentiated by the argument names; and if the number of arguments and the argument names are identical they are differentiated by the argument value types. An object operation method can be implemented in any programming language that is supported by the current embodiment.

An object operation method can be invoked synchronously or asynchronously. When invoked synchronously, the execution will block until the method invocation is complete, optionally resulting in a return value. If invoked asynchronously, the execution will not block. Instead, the external actor specifies an object instance that will be interfaced by the Object Runtime Environment when the method invocation is complete, attaching any return value as an argument. Also, an external actor such as a user, device or another object can specify a specific object instance to be used to monitor or observe the invocation of the object operation method.

As mentioned above, an object that is defined as native have two object models, i.e. one in the runtime environment and one in the native environment. Both object models can interact with each other. For example, native methods can invoke non-native object operation methods within the same object and vice versa. Furthermore, objects can invoke native object operating methods in other objects too. Also, any attributes defined as native are always kept coherent in the two object models. For example, if the attribute value is changed in one object model, the change is propagated to the other object model.

Aspects of Objects

An object exists in different aspects, in one embodiment comprising the following five aspects.

Object Definition:

An object is defined by its Object Definition. It defines the object's attributes, methods, presentation, inheritance, concurrency, transaction isolation etc.

Object Blueprint:

An object blueprint defines an interface of an object, or blueprint, that is exposed to external actors. The blueprint is created automatically from the Object Definition.

Object Deployment Descriptor:

An object deployment descriptor declares the usage and the level of usage of Object Runtime and Native Environment built-in services such as transactions, concurrency, garbage collection, secure communication, etc. Two Deployment Descriptors can exist for any object; one that is a part of the object and one that can be supplied by other functionalities of the system.

Object Instance:

When an object is instantiated or an object reference is de-serialized, i.e. when an object represented with binary data or XML is transformed to its proper format, an object instance is created. An object instance can exist in two different modes, viz. active or inactive. An active instance is an object instance currently deployed in an Object Runtime Environment and its inactive counterpart is an object instance currently serialized. An active instance is always local for an Object Runtime Environment and is unable to be directly accessed or interfaced by an external actor. An object instance is always interfaced using an object reference.

Object Reference:

External actors never interact with an object instance directly. Instead there is always an object reference that references the object instance. So for example: If an object instance A (that is located in Object Runtime Environment A) wishes to interact with an object instance B (that is located in Object Runtime Environment B), the object instance A must first acquire a reference to instance B. The acquired object reference is then located in Object Runtime Environment A, whilst the actual object instance is located in Object Runtime Environment B.

Objects in the Form of ODL Documents

Objects are preferably defined in the Object Definition Language, which is a subset of the eXtensible Markup Language. The Object Definition Language enables object developers to define objects, independent of hardware-technology, -configuration, network-topology, -semantics, -protocols, logic implementation language, physical differentiation. It provides the developer with an abstraction, enabling the developer to focus on the object's interface and functionality. This enables the developer to isolate the native/technology-dependent aspects of the object. The object definition language provides a syntax for inheritance, abstraction and encapsulation.

Objects in the Form of XDF Documents

An important feature of the present invention is that all information is preferably stored in the eXtensible Document Format (below referred to as XDF format) which is the single document format of the system 10. The XDF format can be used to describe any type of functionality or content. Since there is no type attribute connected to an XDF document, there is no difference between, for example, an image and an advanced e-commerce deployment service in the way that the information is structured and stored. From the user's point of view, there is no difference between a layout document and a mail Service.

Several XDF documents may be merged together and form a new XDF document that contains the merged documents, i.e. the new XDF document inherits content and properties from the merged documents. In the architecture according to the invention there is devised inheritance from a single abstract or concrete definition of an object and from an unlimited number of object interfaces. In the invention polymorphism of the objects is devised through interfaces and an object inheriting content or properties from several interfaces can be morphed or transformed to any of these interfaces.

The XDF documents contain both the data, the presentation of the data and logic. Instead of opening the XDF document in different applications, the XDF documents may carry the information on how to present the XDF documents themselves so that the XDF documents may be adapted to any suitable format before the documents are sent to the requesting user.

An XDF document is, preferably, constituted of objects which represent the smallest piece of functionality in the system. For example, an object may be a button, an image editor or a shopping cart. An object has a clearly defined functionality. For example, an image object has, as its only purpose, to show the user an image. A controller object connects interface objects with server side logic. An object could be a derived object, i.e. constructed of a number of other objects, or an atomic object. An atomic object is a basic building block and is essential in the adaptation process. An object contains a number of properties. Some of these properties are general for all objects such as name, x-position, y-position, z-depth, width and height. Other properties are specific for the object type. In general, all services made available by the system 10 are a combination of objects.

Physical Objects

According to embodiments of the invention an object can represent physical entities as well as software entities. For example, the physical entity can be a robot, a lamp or a dishwasher, and a software entity can be a user focused service such as a word processor or a control service in a physical device. In the case of a robot, a robot object instance would represent an actual robot, for example used in a production facility. The object instance would then represent an interface to the robot and other objects can be arranged to interface with the robot object to control the associated actual physical robot device. Common for physical entities that are represented by objects, is that the Object Runtime Environment and the object instances representing the robots would be deployed on a central location in the production facility. Meanwhile, the actual robot would only host the native aspects of the object representing it, thus in a Native Environment.

Platform Overview—Embodiment of Architecture

The technology architecture of the invention is based on three major components, viz. the Object Runtime Environment, the Native Environment and Object Connectivity. These components are preferably implemented in software code and are in different embodiments available or located distributed in different possible configurations in different hardware nodes or are located together in a common hardware node. These components also represent three different perspectives from which any object can be viewed. The platform independent part of an object is deployed and managed by the Object Runtime Environment. The platform dependent or native part or parts of an object is deployed and managed by the Native Environment. The connectivity of an object to external systems, such as Enterprise Information Systems or databases, is handled by the Object Connectivity component. Inside the Object Connectivity component, this connectivity is handled by Connectors, which are not a part of an object but are global for the Technology Provider they are deployed on. The Connectors are predefined software code portions and protocols that are devised to interface and execute data communications between an internal and an external entity. An internal entity is situated within and an external entity is situated without the defined runtime and native environments.

When combined together in different constellations and when certain extensions, such as routing are made, the three components Object Runtime Environment, Native Environment and Object Connectivity form two actors in the technology architecture of the invention, viz. a provider and a consumer. These actors build and constitute technology federations (mentioned above.

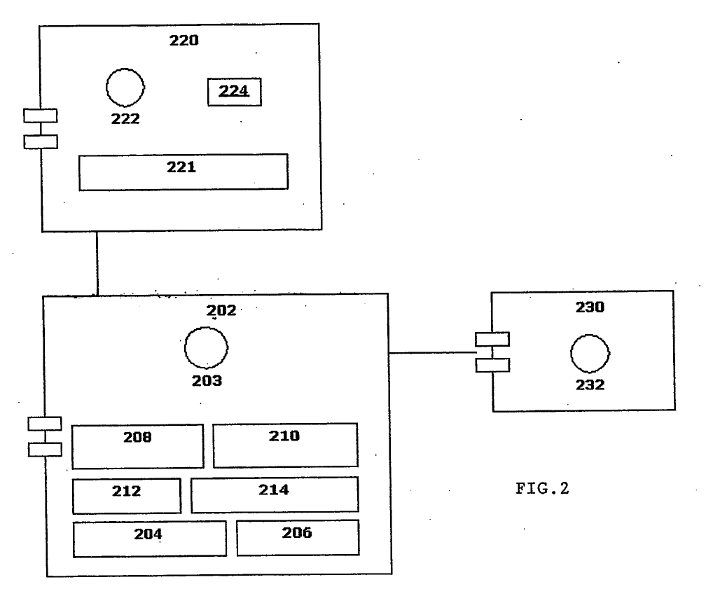

FIG. 2 shows a schematic block diagram of the technology architecture, thus comprising a predefined object runtime environment 202, a predefined native environment 220 and a predefined object connectivity component 230 in its turn comprising a connector 232. These components are mutually communicatively coupled or couplable in order to communicate control data or information when operating on objects.

Object Runtime Environment

The primary function of the Object Runtime Environment 202 is to manage objects and to facilitate any request from the objects that are within its management. It also provides a number of predefined standard services to users and objects as well as implements a comprised security model. In FIG. 2 an object 203 that is dwelling in the Object Runtime Environment 202 is symbolically depicted as a circle. The object runtime environment 202 comprises in different embodiments optional configurations of the following components.

An object model 204 is comprised in the object runtime environment to enable instantiation and managing of object instances. All object instances instantiated within a certain Object Runtime Environment is aggregated in the object model of this Object Runtime Environment.

A security module 206 is comprised to define a specific security enclosure for each object dependent on a predefined object specific security level or security clearance with regard to accessability and communication. Thus all objects deployed in an Object Runtime Environment are placed in such a security enclosure that can be more or less restrictive to an object, depending on its security level or clearance. For example, the security clearance is higher if an object is certified.

A number of execution modules 208 are comprised in the Object Runtime Environment 202 in order to support different programming languages (e.g. Java) that require support for code execution platforms (e.g. JVM). Preferably, the Object Runtime Environment 202 utilizes pluggable execution modules to execute object logic, i.e. modules that are simple to add or remove by means of a common predefined connection interface. Each execution module 208 defines which code execution platform it handles. The Object Runtime Environment 202 then delegates the execution of object logic to the different execution modules at runtime. In presently preferred embodiments, a JavaScript execution module is comprised in all deployments of the Object Runtime Environment 202.

In order to dispose with used up data the object runtime environment 202 preferably comprises a garbage collector module 210 that is devised to support distributed garbage collection. The distributed garbage collection is devised to remove an object instance that is no longer used by any other local or distributed (remote) object instance. Preferably, the use of or interaction of objects and/or deployments of objects with the garbage collector 210 at runtime is optional.

A Transaction Processing Monitor (TP Monitor) 212 is comprised for managing distributed transactions and interacts with all transaction participants. These participants can be objects as well as connectors. Distributed transactions are transactions that involve or runs on a plurality of nodes in a distributed data processing system, thus a plurality of transactional operations that all have to be successfully performed or all cancelled and rolled back. Preferably, only one monitor is engaged in a transaction, and that monitor is the one deployed in the Object Runtime Environment where the transaction was initiated. Preferably, the support of a TP monitor should be present in every Object Runtime Environment deployed. A TP monitor is used indirectly by objects in the sense that the TP monitor is activated to operate in transactions involving an object without being actuated or called by the object itself.

A Concurrency Monitor 214 is comprised in the Object Runtime Environment 202 to monitor access to object operation methods, i.e. invocations of object operation methods, and enforces the concurrency integrity that is specified by the object in its object definition. Preferably, a concurrency monitor should be comprised in every Object Runtime Environment 202 deployed.

Native Environment

FIG. 2 thus further shows a Native Environment 220 communicatively coupled to the Object Runtime Environment 202. The Native Environment is used to deploy any native aspects of an object in a distributed data processing system, that is the native aspects of an object are those that are platform dependent. A Native Environment is typically deployed in a device or any other type of leaf node in a federation according to the invention. The Native Environment 220 comprises an object model 221, that should always be synchronized with the object model 204 of the Object Runtime Environment 202. There are two types of entities comprised in and managed by the Native Environment, viz. native elements 222 and native containers 224.

A native element 222 represents an object in the Native Environment 220. The native element contains all the native aspects of the object it represents. It can contain attributes, object operation methods and/or presentation. In a native element, the presentation is not a composition of attributes; instead it is a native logic (i.e. software code) interacting directly with the Graphical User Interface (GUI) Application Programming Interfaces (APIs) of the device.

According to the invention, a native element must preferably be coherent with the object is represents. If the value of an attribute that is defined native in an object's object definition is changed in the native element, the value must be also be updated in the object that the native element represents and vice verse. Moreover, a native object operation method that is comprised in a native element, can be invoked by the object it represents. A native object operation method can also be invoked by external actors, if it has been declared in the public scope. A native object operation method can, correspondingly, invoke object operation methods in the object it represents, but invocations of object operation methods in an object from a native element are restricted only to the object, which the native element represents.

A Native Container 224 represents a graphical container, e.g. a window, in a Native Environment 220. Native containers are optional in different embodiments because not all Native Environments will be deployed in environments where a Graphical User Interface is applicable or available.

The Native Environment 220 and the Object Runtime Environment 202 are in different embodiments deployed on different or on the same hardware node. In both cases the Native Environment and the Object Runtime Environment are devised such that they are capable to communicate, in order to the meet the requirement concerning coherency in data.

Consumer Functionality

A consumer functionality is established by configuring (again referring to FIG. 2) an object runtime environment 202 associated with a native environment 220. Possibly, the native environment 220 is also associated with one or more input/output interfaces (not shown), for example a drawing API or audio playback device, dependent on the specific application. The consumer functionality enables objects to be autonomously deployed and instantiated at runtime and to collaborate with other, local as well as remotely situated, object instances. The consumer functionality is often deployed in the leaf (outmost) nodes of a federation, and are often positioned in network devices (e.g. internet appliances) where direct bidirectional user input and output is required.

Optionally a consumer functionality can also comprise an object connectivity function. The connectivity function is primarily used for interoperability with external data sources and systems, which however is seldom done in the outer or outmost nodes of a system. In presently preferred embodiments, the consumer functionality comprises the availability of a JavaScript Execution Module. Optionally, there may also be comprised availability of an additional execution module such as the Java Execution Module.

Provider Functionality

A provider functionality is established by configuring (again referring to FIG. 2) all the three major components, i.e. an object runtime environment 202, a native environment 220 and an object connectivity functionality 230, and additional provider specific components. The additional provider specific components comprise optional configurations of a routing component, a security (or authentication) component and a provisioning component (not shown), that all are communicatively coupled to the object runtime environment 202. Thus, the provider functionality provides all the functionality that a consumer functionality provides together additional functionality of said added components. Presently preferred embodiments of the provider functionality comprise the availability of JavaScript and Java execution modules, whereas availability of additional execution modules is optional.

The routing component enables routing of input data, output data and calls (stimuli) within a federation. This is described in more detail below. The authentication component provides authentication facilities for instances of consumer functionality that request to become a part of a federation. In presently preferred embodiments the activation of this component is optional. The responsibility for this component is primarily to authenticate a consumer establishing contact or participation in a federation, whereas the task to authenticate an actual user to the system is handled at another level.

The provisioning component enables provisioning of objects to consumers. It manages object inheritance as well as device profiling, thus relieving the consumer functionality from those, rather processing and I/O intensive tasks. For example, the provisioning component can be devised to provisioning objects over HTTP.

Federations

A federation in accordance with the invention comprises a provider functionality (also called provider) and one or more instances of consumer functionality (also called consumers). The provider functionality serves as a central hub in a federation and consumers are nodes. In a federation all the consumers are devised to have a direct communication channel with the provider functionality. Consumers can also have a certain level of awareness of or information about each other and can optionally even have direct communication channels between them. Between consumers where direct communication channels exist communication is performed using the communication channels. If direct communication channels does not exist, the provider is used to route communication between consumers.

Within a federation, objects can seamlessly collaborate and interact. When an object that is deployed within a first consumer wants to interact with another object that is deployed within another, second consumer, the stimuli in the shape of calls can normally be communicated in two different ways. If a direct communication channel exists between the two consumers, the action stimuli and, if applicable, re-action stimuli are sent using that direct communication channel. If no such direct channel exist, the action stimuli and the re-action stimuli is routed by the provider. When routing, the provider utilizes its direct communication channel with each of the two involved consumers to send and receive the stimuli.

If an object that is deployed within a consumer wants to interact with another object that is deployed within a provider within the same federation, there is always a direct communication channel and no routing is required.

Scenarios

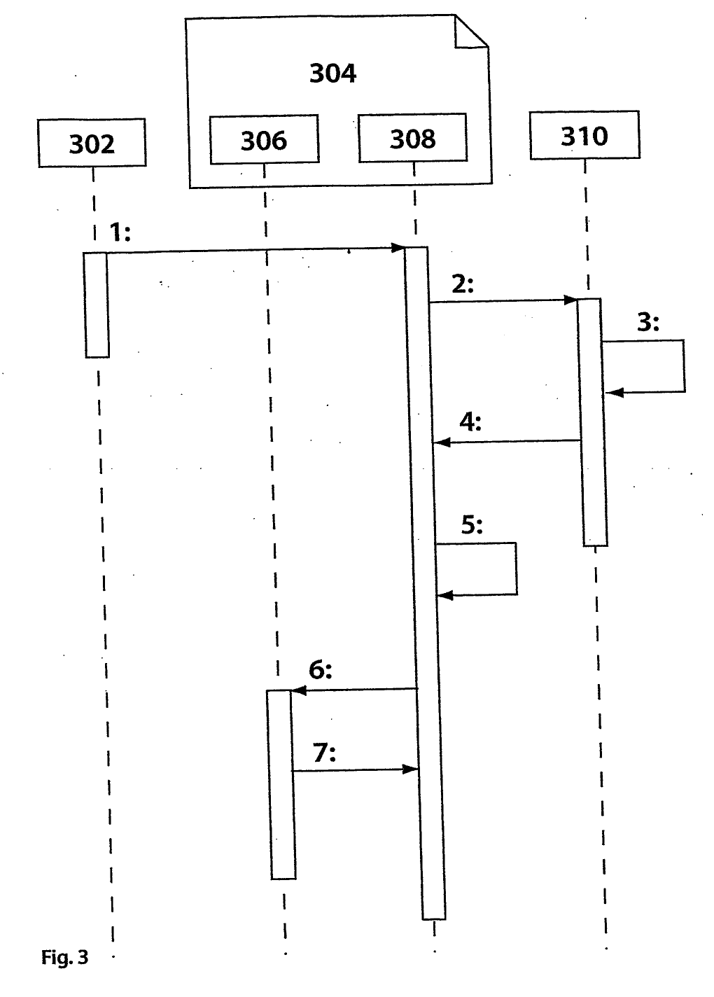

Exemplifying scenarios of signal patterns according to embodiments of the invention are shown in overview sequence flow diagrams in FIG. 3-FIG. 5.

FIG. 3 shows a scenario of a user requesting an object for utilizing an image editing service. Thus a user 302 signals by means of a signal (1: request Image Editing Service Object) to a consumer functionality 304 (corresponding to a client in a client/server-architecture) that it wishes to use an image editing service accessed through a dedicated object. The consumer functionality 304 comprises a native environment 306 and an object runtime environment 308. The object runtime environment 308 has a device or technology profile that is dependent on the currently active user, for example specifying a user access device such as a mobile WAP browser or an stationary computer web browser.

The object runtime environment 308 of the consumer 304 (i.e. the client) then sends a request for the image editing service (2: request Image Editing Service with device profile) to the provider functionality 310. The provider 310 (corresponding to a server in a client/server-architecture) then profiles or adapts the requested object for the device or technology profile specified by the consumer object runtime environment 304 (3: profile object for specified device). Thereafter, the provider 310 returns or provisions (4: return/provision object) the requested and by now profiled object to the object runtime environment 308. When the object is received by runtime environment 308 of the consumer 304, the object is instantiated (5: instantiate object), i.e. an object instance is created. If the object contains any native aspects, these are propagated to the native environment 306 of the consumer 304 (6: propagate native aspects) and a return signal (7: return) is sent back to the object runtime environment 308 as a confirmation. Thereafter, the thus profiled image editing service is made available to the user 302.

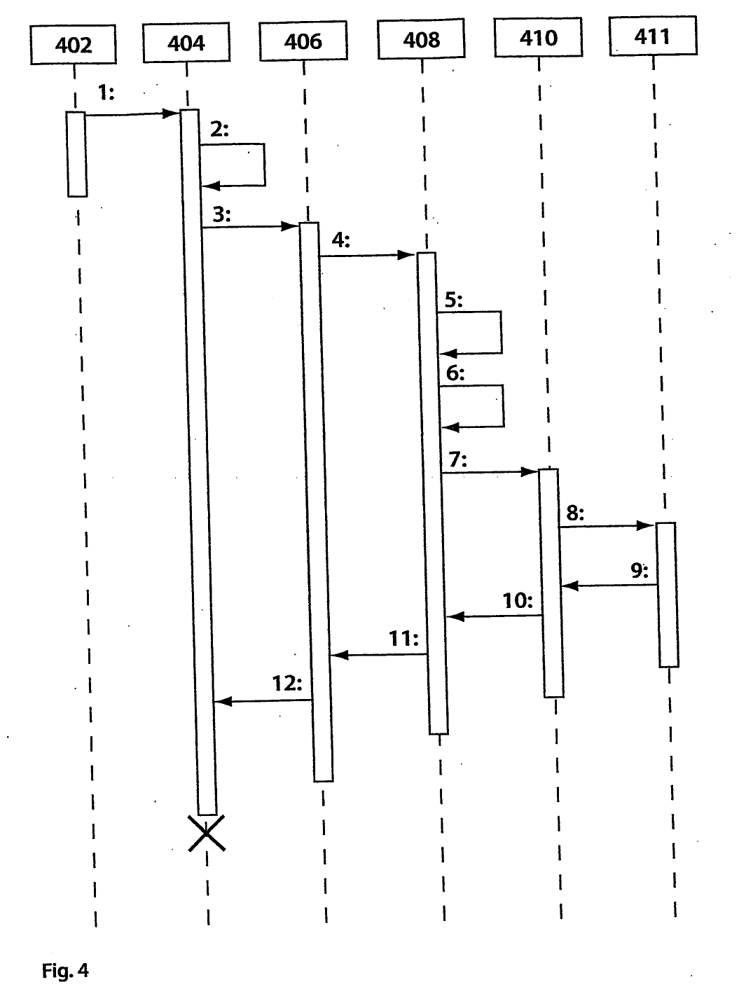

FIG. 4 shows a scenario of a user invoking a local object operation method. A user 402 operates on an image by means of a user interface, for example a grafical user interface (GUI) that in this example is assumed to comprise a native aspect in the shape of a field representing a control button for activating a service for sharpening the image. First, the user 402 clicks on the sharpen image button and thereby sends a signal (1: click on location x,y in GUI). The user interface is normally a part of the native environment and therefore the user click event is handled by the consumer native environment 404. The consumer native environment 404 resolves on which native aspect in the GUI the user has clicked (2: resolved click to be on sharpen image button). In this case the click was performed on the x and y coordinates of the GUI, which is predefined to be within the sharpen image button. The native environment 404 then sends an on-click event signal (3: send onclick event) to a sharpen image button native aspect 406. The sharpen image button native aspect 406 then invokes an object operation method in the object it is associated to by means of a signal (4: invoke on-action operation method in object logic) to the consumer object runtime environment 408. The object operation method is dispatched by the object runtime environment 408 (5: resolve implementation for on-action operation method in button object), which resolves the adequate method implementation for the on-action object operation method (6: resolve implementation language). When the adequate object operation method implementation is found, the the object runtime environment 408 activates (7: execute object logic for on-action object method) an execution module 410 to execute (8: execute) in a sharpen image button object 411 the object logic for the object operation method implementation dependent on the operation method implementation language (e.g. Java or Javascript) and returns (9: return). When the execution model returns (10: return) also the object runtime environment returns (11: return) and the sharpen image button native aspect 406 becomes active again. In this scenario the button native aspect has accomplished everything that it was designed to do and a current execution session in the button native aspect 406 terminates in a return (12: return) to the native environment 404. The aspect itself remains in an existing waiting state in order to respond to possible sequential events from the native environment 404.

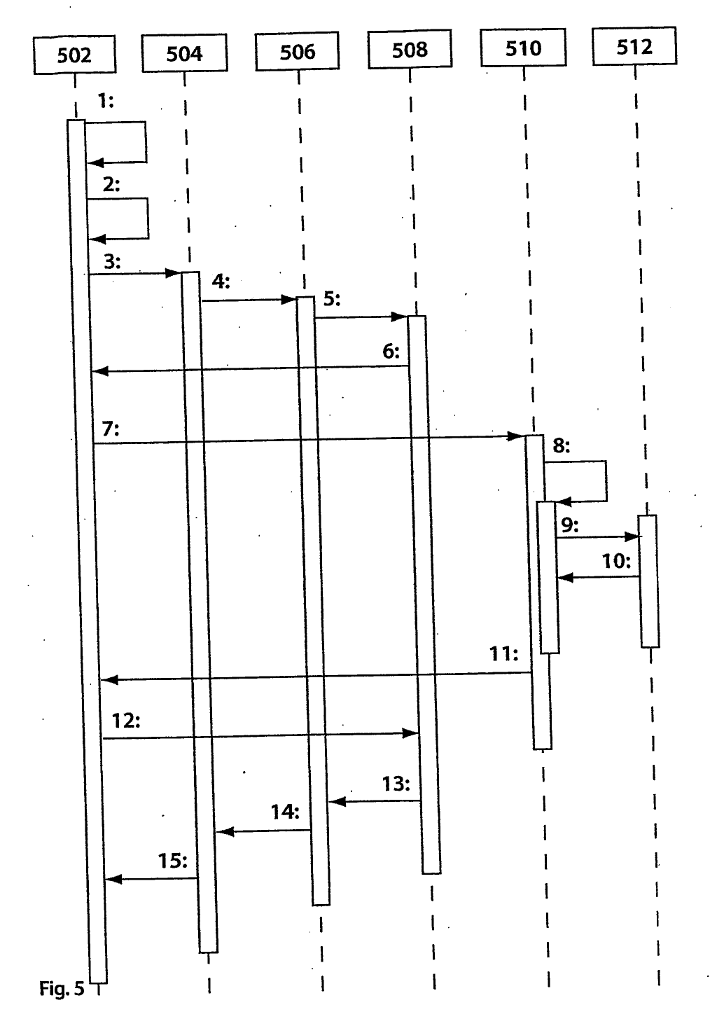

FIG. 5 shows a scenario of a consumer invoking a remote object operation method and is based on the previously described scenario of FIG. 4 with a user invoking a local object operation method for manipulating an image. In FIG. 5 a consumer object runtime environment 502 (1:) resolves the implementation for an on-action object operation method in the button object and (2:) resolves the implementation language. Thereafter, (3:) object logic for on-action object operation method is executed by means of an execution module 504 that (4: execute) invokes execution of a sharpen image button logic 506. When the button object logic 506 is executed it interfaces a sharpen filter object reference 508, which is a reference to a remotely available/distributed sharpen filter object 512 that performs the actual sharpening of the manipulated image. The sharpen filter object 512 is deployed and is dwelling on a second, remotely situated object runtime environment 510 that in this configuration constitutes a provider functionality.

When the button object logic 506 invokes the apply filter operation method (5: invoke applyFilter method) on the sharpen filter object reference 508, the latter communicates via the consumer object runtime environment 502 (6: invoke remote operation method apply filter) with the object 512 that it references to. The consumer object runtime environment 502 sends an (7: invoke method request) invoke object operation method request to the remote provider object runtime environment 510. Thereafter a local object operation invokation procedure as described in the scenario of FIG. 4 takes place within the remote provider object runtime environment 510. That is, the remote provider object runtime environment 510 (8: invoke local object method) invokes a local object operation method, whereupon (9: execute object logic) execution of object logic in the sharpen filter object 512 takes place. When the local object operation method returns (10: return) to the remote provider object runtime environment 510, the latter sends (11: invoke method response) an invoke object operation method response to the consumer object runtime environment 502. The consumer object runtime environment 502 (12: return) returns to the object reference 508, which returns (13: return) to the button object logic 506, and the returns goes on from the object logic 506 (14: return) to the execution module 504 and back (15: return) to the consumer object runtime environment 502.

In fully functional scenarios some of the calls and signal communications would involve a number of arguments or parameters, but for the sake of simplicity in explanation this is not shown in the figures.

Embodiment Realizing an Data Network Based Operating System

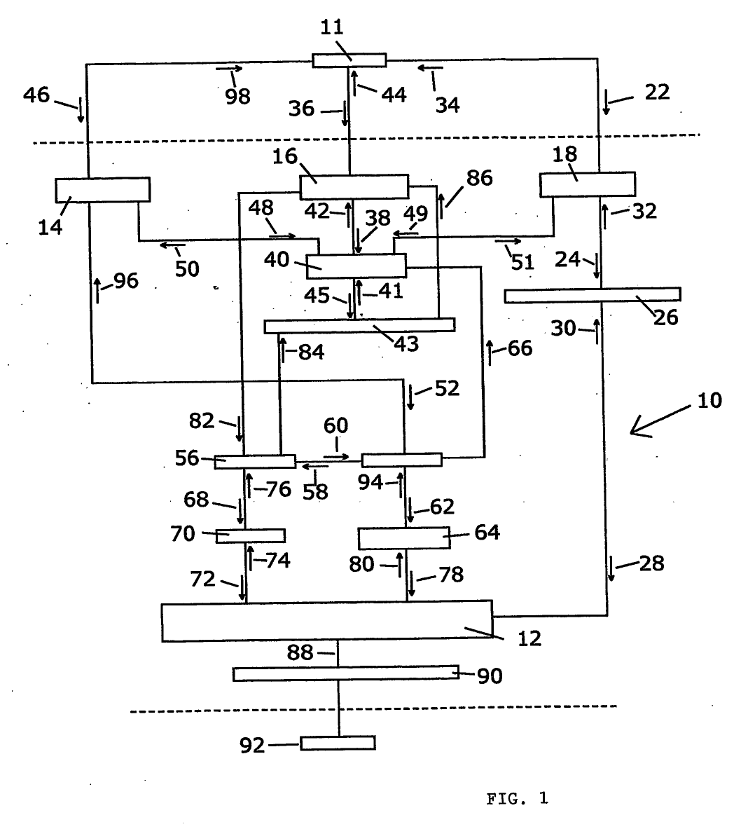

One embodiment of the invention is shown in FIG. 1, and comprises an operating system 10 designed in accordance with the present invention. This operating system 10 is a network based, such as an Internet based, platform that enables a user 11 to gain access to a wide range of services. In general, the user 11 may log into a web site and use the powerful resources of a content distribution and an object connecvtivity component in the shape of a synchronization server 12 and other functionalities connected to the system 10. For example, the user 11 may purchase, subscribe or lease services as they are required. The user 11 may conveniently gain access to the same information whether the user operates from a conventional computer, a WAP device, a mobile phone or any other communication device that is connectable to the system 10 via the Internet without the need for any cumbersome conversion or synchronization routines.

The system 10 has a provider object runtime environment in the shape of a behave server 14, a provider provision extension in the shape of a service delivery server 16 and a file delivery server 18 that may communicate with the user 11. The behave server 14 may directly be used by external actors to interact with services and to perform certain behave scripts such as data manipulation or execution of logic. The service delivery server 16 acts upon external requests for services, loads the service, adapts it and then delivers it to the external user 11 who requested it. The file delivery server 18 acts upon external requests for a certain file, loads the file, adapts it and then delivers it to the requesting user 11. For example, the user 11 may request access to a service, such as a word processing service or any other functionality or service made available by the system, by sending a request service signal 36, i.e. a request object signal, to the service delivery system 16.

The behave server 14 may be used when the user 11 needs to manipulate the information, such as documents, delivered by the service delivery system 16 and file delivery system 18, as described in detail below.

Upon proper authentication of the user 11, the user may send the request service signal 36 to the system 16 that receives the signal 36 and sends a session lookup signal 38 to a session server 40 to determine if there is a pre-existing session associated with the user's request. If there is a session stored in the session server 40, the server 40 sends back a deliver session signal 42 to the system 16 that in turn sends a deliver service signal 44, including the requested service, back to the user 11. If there is no session in the session server 40 then a new session may be set up.

The user 11 may start working with a document by using one type of communication device, such as a desktop computer, and then continue working with the same document using a different type of communication device such as a PDA or WAP phone. The system 10 automatically takes care of any required adaptation of the format for the user to gain access to a service.

The user 11 may also request access to a previously stored file, such as a JPEG picture, sound clip or video file, by sending a request signal 22 to the system 18. A new file may be created by a service using a behave script using logic executed by the SPU. Upon receipt of the signal 22, the file delivery system 18 sends a load and adapt file signal 24 to a file adaptation unit 26. The unit 26 receives the signal 24 and sends a load signal 28 to the server 12. The server 12 receives the signal 28 and finds the requested file and sends back a deliver file signal 30 including the requested file information to the unit 26. As mentioned above a single document format (XDF or ODL) is used to describe any type of functionality or content.

The user 11 may just open any document or start with an empty document. Since there is no type attribute connected to an XDF document, there is no difference between, for example, an image and an advanced e-commerce deployment service in the way that the information is structured and stored. From the user's point of view, there is no difference between a layout document and a mail Service. New documents may be named at the time of creation and saved continuously and automatically.

The unit 26 receives the signal 30 and converts the file information to a format, such as JPEG, WBMP etc., that is suitable for the communication device used by the user 11. For example, if the user 11 is using a PDA when communicating with the system 18 then the unit 26 sends back a deliver adapted file signal 32 in a format that is suitable for the PDA. If the user is using a conventional computer, the signal 32 is in a format that is suitable for the computer and so on. In this way, the format is always adapted to the communication device the user 11 is using when communicating with the delivery system 18. The delivery system 18 receives the signal 32 and forwards the information in a deliver file signal 34 back to the user 11.

As indicated above, the user 11 may also request a service by sending a request service signal 36 to the service delivery system 16. Preferably, a Service must be requested before files are requested. In general, a user 11 may always request a service before the file delivery system 18 and the behave server 14 are used. The service may provide access to a word processing service or any other type of service such as picture or video related services. Thus the user 11 may gain access to the requested word processing service without having a word processing program installed on the communication device that is used by the user 11 to communicate with the system 16.

As mentioned above, the behave server 14 may be used when the retrieved services or documents require manipulation. For example, when the user 11 would like to make a picture sharper that is downloaded from the file delivery system 18, the user 11 may broadcast an object operation method invokation in the shape of a behave event signal 46 to the behave server 14 to inform the server 14 about the required event that the picture should be made sharper. The server 14 sends a session lookup signal 48 to the session server 40 to find out if there is a previously stored session in the session server 40 and to identify the user 11. Similarly, it should be noted that the system 18 also sends a session lookup signal 49 to the session server 40 when a file is requested, as described above. The system 18 then receives a deliver session 51 in response to the signal 49.

If there is a previously stored session in the server 40, the server 40 sends back a deliver session signal 50 to the server 14 that receives the signal 50 and the server 14 sends a signal for executing an object operation method implementation in the shape of a execute behave script signal 52 to a behave runtime device 54, the latter being an objcet runtime environment core. The signal 52 may include object operation implementation logic, i.e. software code, in the shape of the script commands that are required to accomplish the requested event. The signal 52 may be in the XDF format or any other suitable format. The device 54 receives the signal 52 for the event of the behave script, i.e. the object operation method invokation, such as making a picture sharper, and obtains the required logic in the shape of a script. The device 54 then reads or interprets the script that constitutes the object operation method implementation and may, depending upon the type of event, execute logic or manipulate binding data. The latter is in principle mutation of attributes in an object by the object itself indirectly through the object runtime environment.

More particularly, the device 54 receives the signal 52 and loads the script, i.e. implementation logic for the object operations method related to the sharpness of the picture from a service runtime device 56 by sending a load behave script signal 58 thereto. Preferably, the signal 58 is always sent to the device 56 to obtain the required script. The device 56 receives the signal 58 and sends a prepare service signal 68 to a XDF runtime device 70, which is an object model that is a part of the object runtime environment. The device 56 may also receive an invoke service signal 82 from the service delivery system 16.

The device 70 receives the signal 68 and sends a load service resources signal 72 to the server 12. The server 12 responds by sending back a deliver resources signal 74, including the requested resources, to the XDF runtime device 70. The device 70 may load one XDF document from the device 12 and then propagate data in the document to the current session binding pool. The device 56 may be designed to handle the request and response administration for the device 70. More particularly, the device 70 may then send a deliver service signal 76 to the service runtime device 56. The device receives the signal 76 and sends a deliver behave script signal 60 back to the device 54. If the device 56 activated the device 70 as a result of the invoke service signal 82, then the device 56 may send back an adapt service signal 84 to the service adaptation device 43, which is a part of the provision extension to the provider, that may forward the information in a deliver adapted service signal 86 to the service delivery system 16. However, before the signal 84 is sent to the system 16, the device 43 may send a load bindings signal 41 to the service adaptation unit 43 that sends back a deliver bindings signal 45 including the required bindings.

When the device 54 has received the script signal 60, the device 54 determines the next steps which may include sending an execute logic signal 62 to a service processing unit 64, i.e. an execution module, or a manipulate bindings signal 66 to the session server 40. The first time a service is loaded, one or more behave scripts may be executed even before the service has reached the requesting user 11. For example, if a credit card transaction service is to be delivered, it may be necessary to prepare the request by executing logic when the request is sent to the credit card company but before the service is delivered to the client.

With reference to the above example of making a picture sharper, the device 54 sends the execute logic signal 62 to the device 64. Because the sharpness of the picture is a mathematical calculation that is applied to the picture, it is necessary for the device 54 to send the execute logic signal 62 to the processing unit 64. The unit 64 receives the signal 62 and sends a load logic and content signal 78 to the server 12. It should be noted that the device 64 may communicate with some external systems without using the device 12. The server may send a transaction signal 88 to an external content adaptation unit 90 that communicates with an external actor 92, such as a database. When the requested transaction is carried out by the server 12, the server 12 responds to the unit 64 by delivering a transaction state by using the deliver signal 80. When the unit 64 receives the signal 80, it sends a deliver resources signal 94 to the device 54 that, in turn, sends a deliver resource signal 96 to the behave server 14. The server 14 then sends a deliver response signal 98 back to the user 11. In this way, the unit 64 carries out at least two steps including up-loading logic, for making a picture sharper, and loading the picture itself from a cache location.

As mentioned above, the behave runtime device 54 may send the manipulate bindings signal 66 to the server 40. For example, the signal 66 may manipulate stored bindings in the session server 40 to make the picture sharper so that future service requests will operate with the manipulated sharper picture. The signal 66 is related to a binding pool that is created whenever a new session is created in the session server 40. For example, the binding pool includes all the data that is required to describe all the variables that are active depending upon the services that are currently loaded. Regarding the picture example, the binding pool may, for example, include the width, height and location of the picture. If the session concerns a word processing document, the signal 66 may include instructions to make a text segment bold by manipulating the bindings, such as adding tags for bold text, that are related to the text segment. In general, the signal 66 does not involve any logic and requests less complicated changes of the picture compared to changes that require the execution of logic in the device 64. It should be noted that the information to actually make the actual display of the picture sharper for the user 11 is sent via the behave server 14 and the deliver response signals 96 and 98.

The system 10 may import information from a large number of databases and assemble and present the information in one document because all the external information is adapted to the XDF format by the external content adaptation unit 90, which is an object connectivity component, before it is stored in the server 12. For example, the system 10 may import hundreds of databases for film reviews in many formats and merge all the database information into one database in one format that includes the film reviews from all the external databases. In conventional systems, imported databases must be kept separate within the system.

The user may gain access to very powerful services, functionalities and resources provided at the server although the communication device itself is relatively primitive because it is not necessary for the communication device to have any powerful programs installed. It is sufficient for the user to gain access to the resources of the system 10 and utilize the processing power of the system 10 which substantially reduce the processing power required of the computer device used by the user 11. When the user 11 logs out from the system 10, all sessions in the session server 40 are, preferably, saved in the server 12.

When a user edits the document, changes are broadcast to the other users. More than one user may edit the same document simultaneously provided they work on different parts of the same document.

Preferably, each behave server 14, service delivery system 16 and file delivery system 18 has a core module that may include the service runtime device, the behave runtime device, the XDF runtime device and the service processing unit.

The invention has been explained above by means of exemplifying embodiments, and it can be implemented in various other ways within the framework of the accompanying claims.

1-28. (canceled)

29. A method for processing data objects in a distributed data processing system, said distributed data processing system having a plurality of software and/or hardware nodes being communicatively connectable, the method comprising the steps of:
defining a first object processing environment for processing objects at a first level of abstraction, said first object processing environment comprising a first object model with a first category of object aspects, wherein the processing of said first object processing environment is independent of the software/hardware platforms of said nodes;
defining a second object processing environment for processing objects at a second level of abstraction, said second object processing environment comprising a second object model with a second category of object aspects, wherein the processing of said second object processing environment is dependent on the software/hardware platform of at least one of said nodes;
synchronizing said first object model of said first object processing environment with said second object model of said second object processing environment, such that data coherency is maintained in said first and second object models;
defining an object in accordance with said first and second models and for said object associating a selectable set of object aspects from said first and second object aspect categories;
processing an instance of such an object according to said first and second object models in said first and second object processing environments dependent on said associated set of object aspects.

30. The method as recited in claim 29, wherein predefined object connectivity means, in the shape of software code portions and protocols communicatively coupled to said first, platform independent environment, are devised to interface with and execute data communications between an internal entity situated within and an external entity situated outside said defined first and second environments.

31. The method as recited in claim 29, wherein an instance of said first, platform independent environment is configured together with an instance of said second, platform dependent environment and object connectivity means to constitute an object provider functionality.

32. The method as recited in claim 29, wherein an instance of said first, platform independent environment is configured together with an instance of said second, platform dependent environment to constitute an object consumer functionality.

33. The method as recited in claim 32, wherein an object provider functionality is configured together with an object consumer functionality constituting a consumer/provider subset of the distributed system.

34. The method as recited in claim 33, wherein routing means enables routing of data and control signals within said consumer/provider subset of the distributed system.

35. The method as recited in claim 34, wherein authentication means provides authentication functionality in accessing said consumer/provider subset of the distributed system.

36. The method as recited in claim 35, wherein provisioning means enables provisioning of objects to a consumer within said consumer/provider subset of the distributed system and adapts said objects to the technical configuration of the consumer apparatus.

37. The method as recited in claim 29, wherein said object instance when it is generated is associated with an identification indication that is unique within said distributed system.

38. The method as recited in claim 29, wherein an object is defined by means of a plurality of aspects comprising an object definition, an interface definition, an object instance aspect and an object instance reference aspect.

39. The method as recited in claim 29, wherein data is encapsulated in an object instance by means of an attribute devised to store a selectable predetermined type of basic entity for containing data, said type of basic entity being dependent on the type of data to be stored.

40. The method as recited in claim 39, wherein an attribute of a first object instance is devised to contain a reference to a second object instance for accessing or activating a selectable content of said second object instance.

41. The method as recited in claim 29, wherein an object instance is accessed or activated by means of a portion of executable code associated with said object and devised to perform a predefined task of said object.

42. The method as recited in claim 41, wherein said portion of executable software code is available and devised to activate execution of functionality or operations of said object instance, or to access or manipulate data that is encapsulated in the object.

43. The method as recited in claim 29, wherein information is encapsulated in an object instance at a first node in said distributed system and is accessible, dependent on predetermined access parameters, from an arbitrary second node in said distributed system.

44. The method as recited in claim 29, wherein a service, possibly involving software logic, is encapsulated in an object instance at a first node in said distributed system and is accessible, dependent on predetermined access parameters, from an arbitrary second node in said distributed system.

45. The method as recited in claim 29, wherein an object is devised to represent a physical entity, an object instance thus being defined to access, interface with or control said physical entity.

46. The method as recited in claim 29, wherein all information within the distributed system is stored in a common and single format and structured in a common way independent of the type of said information.

47. The method as recited in claim 29, wherein an object and a software component within said distributed system are expressed in a common predetermined language and with a common predetermined set of language rules.

48. A system for processing data objects in a distributed data processing system, said distributed data processing system having a plurality of software and/or hardware nodes being communicatively connectable, comprising means for realizing the steps of:
defining a first object processing environment for processing objects at a first level of abstraction, said first object processing environment comprising a first object model with a first category of object aspects, wherein the processing of said first object processing environment is independent of the software/hardware platforms of said nodes;
defining a second object processing environment for processing objects at a second level of abstraction, said second object processing environment comprising a second object model with a second category of object aspects, wherein the processing of said second object processing environment is dependent on the software/hardware platform of at least one of said nodes;
synchronizing said first object model of said first object processing environment with said second object model of said second object processing environment, such that data coherency is maintained in said first and second object models;
defining an object in accordance with said first and second models and for said object associating a selectable set of object aspects from said first and second object aspect categories;
processing an instance of such an object according to said first and second object models in said first and second object processing environments dependent on said associated set of object aspects.

49. The system of claim 48, devised as a network based system for enabling a user to gain access to services and files, further comprising:
a distribution and synchronization server devised for distribution and synchronization of service and file data;
a server means devised for usage by external actors to interact with services and for performing scripts defining a predetermined behavior such as data manipulation or execution of logic;
a service delivery server that is devised to act upon requests for services, loads the service, adapts it and then delivers it to a requesting user;
a file delivery server that is devised to act in response to a request service signal for a certain file, loads the file, adapts it and then delivers it to a requesting user.

50. The system of claim 49, wherein the access to information is independent of the user access device, which may be a conventional computer, a WAP device, a mobile phone or any other communication device that is connectable to the system.

51. The system of the claim 49, wherein the server means is used by a user to manipulate information or a service.

52. The system of claim 49, wherein each of said server means, service delivery system and file delivery system has a core module that includes a service runtime device, a behave runtime device, a document format (XDF) runtime device and a service processing unit.

53. The system of claim 49, wherein the system is devised to give access to different functionality dependent on the technical capabilities of the user communication device.

54. The system of claim 49, wherein a service is requested by a user by sending a request service signal to the service delivery system, whereupon any possibly needed software code is executed in the server system and the service is delivered by presenting the resulting information on the communication device of the user.

55. The system of claim 49, wherein the system constitutes an Internet based operating system enabling a user to gain access to services and files.

56. A computer program product for processing data objects in a distributed data processing system, said distributed data processing system having a plurality of software and/or hardware nodes being communicatively connectable, comprising computer program code portions devised to direct a data processing system to perform the steps of:
defining a first object processing environment for processing objects at a first level of abstraction, said first object processing environment comprising a first object model with a first category of object aspects, wherein the processing of said first object processing environment is independent of the software/hardware platforms of said nodes;
defining a second object processing environment for processing objects at a second level of abstraction, said second object processing environment comprising a second object model with a second category of object aspects, wherein the processing of said second object processing environment is dependent on the software/hardware platform of at least one of said nodes;
synchronizing said first object model of said first object processing environment with said second object model of said second object processing environment, such that data coherency is maintained in said first and second object models;
defining an object in accordance with said first and second models and for said object associating a selectable set of object aspects from said first and second object aspect categories;
processing an instance of such an object according to said first and second object models in said first and second object processing environments dependent on said associated set of object aspects.
